(19) United States
(12) Patent Application Publication
(10) Pub. No.: US 2023/0267181 A1
(43) Pub. Date: Aug. 24, 2023

(54) TIME-RESTRICTED AND NODE-LOCKED LICENSE

(71) Applicant: Hewlett-Packard Development Company, L.P., Spring, TX (US)

(72) Inventors: Daryl T Poe, Fort Collins, CO (US); Timothy J Freese, Fort Collins, CO (US)

(73) Assignee: Hewlett-Packard Development Company, L.P., Spring, TX (US)

(21) Appl. No.: 18/005,313

(22) PCT Filed: Jul. 21, 2020
(86) PCT No.: PCT/US2020/042850

§ 371 Date: Jan. 12, 2023

(51) Int. Cl. G06F 21/10; H04L 9/30; H04L 9/32; H04L 9/08; G06F 21/12

(52) U.S. Cl. CPC G06F 21/105; H04L 9/3073; H04L 9/3247; H04L 9/0894; H04L 9/3297; G06F 21/121; G06F 2221/0704

(57) ABSTRACT

A device stores a first public key of a first cryptographic key pair. A second cryptographic key pair node-locked to and stored on the device is digitally signed with a first private key of the first key pair. A license stored on the device is digitally signed with a second private key of the second key pair to node-lock the license to the device, and the second private key is deleted from the device. The license is time-locked to time of digital signature. The license is authenticated against a second public key of the second key pair, and the second public key is authenticated against the first public key. The license is validated against the device and against a current time.

### BACKGROUND

An operating system is system software that manages computer hardware, software resources, and provides common services, including graphical user interfaces (GUIs), for other computer programs to run on a computing device like a desktop, laptop, or notebook computer, among other types of computing devices. An operating system may be considered as the core set of software on a computing device, exposing common system services, libraries, and application programming interfaces (APIs) that other programs can use to run on the operating system. The operating system is thus situated between such other programs and the hardware of a computing device. Examples of operating systems include versions of the MICROSOFT WINDOWS operating system, versions of the LINUX operating system, and versions of the APPLE MACOS operating system, among other types of operating systems.

### BRIEF DESCRIPTION OF THE DRAWINGS

FIGS. 1A, 1B, and 1C are flowcharts of example methods for a time-restricted and node-locked license for a device storing an operating system subject to the license.

FIGS. 2A, 2B, and 2C are flowcharts of example methods for a time-restricted and node-locked license for a device storing software more generally that is subject to the license.

FIGS. 3A, 3B, and 3C are flowcharts of example methods for a time-restricted and node-locked license for a device, which may store software like an operating system that is subject to the license, or may be used in other scenarios, such as for software not stored on the device.

FIG. 4 is a flowchart of an example method.

FIG. 5 is a diagram of an example non-transitory computer-readable data storage medium.

FIG. 6 is a diagram of an example device.

### DETAILED DESCRIPTION

Traditionally operating systems have been tied to the computing devices on which they are installed. To use a different operating system on a computing device, the operating system in question would first have to be installed on the device before it could be booted and executed. More recently, operating system distributions referred to as an “operating system on a stick” have gained popularity, which is a distribution of an operating system on a portable device that plugs into or is connected to a computing device, and which can boot and execute from the portable device without having to be installed on the computing device.

Such distributions, which are also referred to as live distributions, often do not make any changes to their host computing devices during execution. Live distributions are commonly stored on flash drives, such as universal serial bus (USB) flash drives, but can also be stored on portable hard drives and solid-state drives (SSDs). Live distributions are portable, and permit a user to use an operating system on any compatible computing device by simply plugging the portable device into the computing device. When finished, the user can remove the portable device and insert it into a different computing device to use the operating system on the latter device.

Techniques described herein provide for node-locked and time-restricted licenses for such operating systems. The license is node-locked to the device on which the operating system is stored, which is referred to as a license device herein, to prevent the operating system from being executed from a different device if copied to that device. Node-locking the license to the device mitigates software piracy concerns. The license is time-restricted to the date of first use of the operating system at an end user (or a future date), in that the licensing period begins on this date, as opposed to the date of manufacture of the license device, which eases stocking and order fulfillment issues.

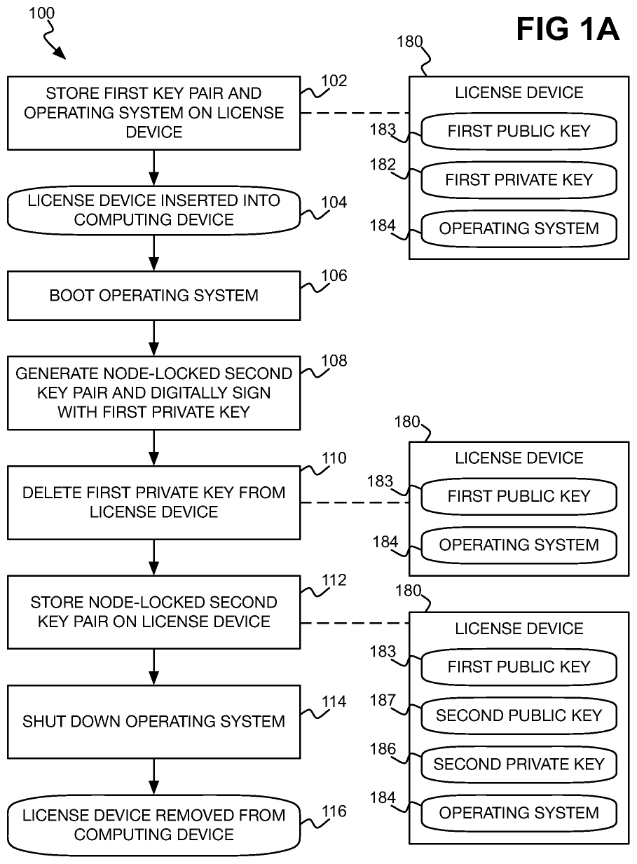

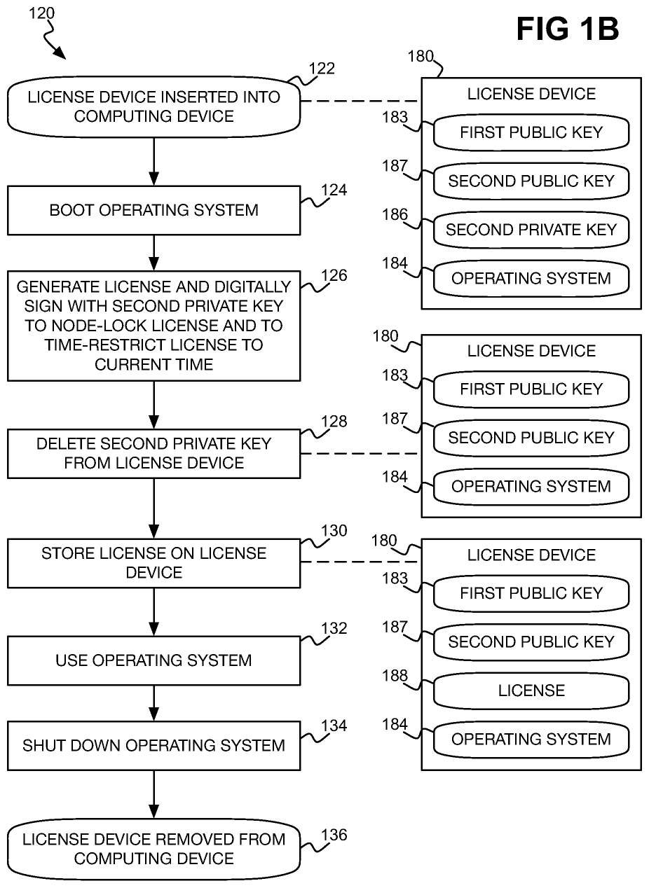

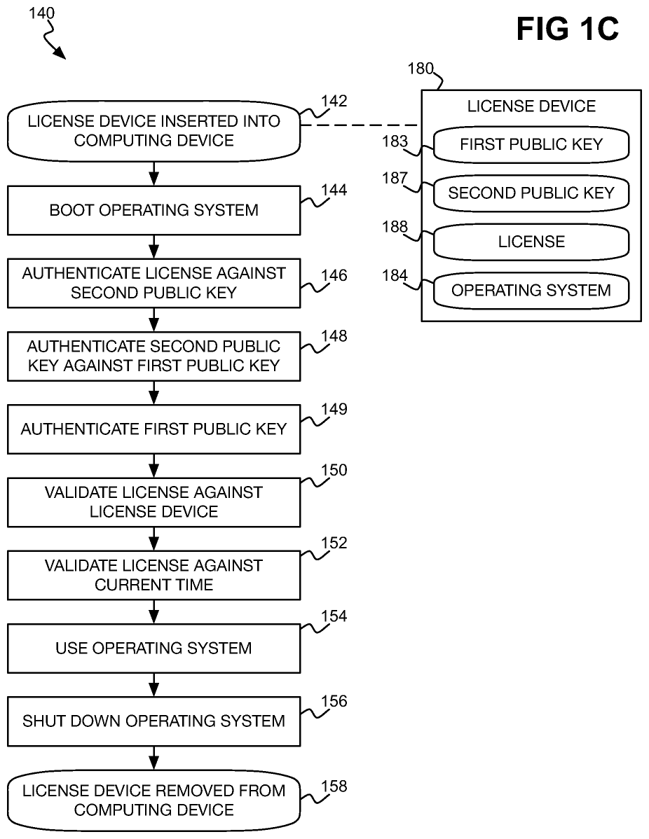

FIGS. 1A, 1B, and 1C show respective example methods 100, 120, and 140 for a node-locked and time-restricted license for a live distribution of an operating system stored on and bootable and executable from a license device, such as a portable storage device like a USB flash drive. At least some parts of the methods 100, 120, and 140 may be implemented as program code stored on a non-transitory computer-readable data storage medium and executable by a processor. For example, the program code may be the operating system itself, the data storage medium may be or be part of the license device, and the processor may be part of the computing device to which the license device has been communicatively connected.

Referring to FIG. 1A, the method 100 is performed at time of manufacture, such as at the factory, to manufacture a license device storing a live distribution of the operating system. The method 100 includes storing a first cryptographic key pair and a live distribution of the operating system on the license device (102). For example, technicians at the factory may employ special-purpose cloning devices that are able to clone a master license device storing the first cryptographic key pair and the operating system to a relatively large number of license devices at the same time.

Each license device has a unique identifier, such as a universally unique identifier (UUID) or a globally unique identifier (GUID). The unique identifier of a license device may be a serial number hardcoded into the license device, for instance. The unique identifier of the license device may not be easily spoofed, in that imbuing an existing license device with the unique identifier of another license device may be difficult if not impossible to do. The remainder of FIGS. 1A, 1B, and 1C is described in relation to one such license device to which the first cryptographic key pair and the live distribution of the operating system have been copied.

The first cryptographic key pair includes a first public key and a first private key. The first key pair is thus an asymmetric cryptographic key pair. The first key pair may be tied to the manufacturer of the license device, or to an authorized distributor, seller, or other party of the license device. The first private key is confidential to this party, whereas the first public key can be disseminated widely, to permit authentication of data signed by the first private key (and to permit encryption of data decryptable by just the holder of the first private key). The first key pair may be self-signed, meaning that it is self-authenticating, or it can be signed (e.g., generated) by a trusted certificate authority, and therefore authenticated against the certificate authority.

The result of part 102 is a license device 180 storing the first public key 183 and the first private key 182 (i.e., the first key pair), and the live distribution of the operating system 184. The method 100 includes inserting the license device 180 into a computing device at the factory (104). (Beginning with part 104, the method 100 is performed individually for each license device to which the first key pair and the operating system have been copied.) Because the distribution of the operating system 184 is a live distribution, the computing device boots the operating system 184 directly from the license device 180 (106). This is the first boot of the operating system 184, which occurs at the factory.

Execution of the operating system 184 causes the computing device to generate a node-locked second cryptographic key pair and digitally sign the second key pair with the first private key 182 (108). The second key pair is node-locked specifically to the license device 180 inserted into the computing device, and thus is unique to the license device 180 (as compared to the first key pair, which is not). For example, the second key pair may encode the unique identifier of the license device 180. The second key pair is, like the first key pair, an asymmetric cryptographic key pair and includes a second public key and a second private. Digitally signing the second key pair with the first private key 182 permits authentication of the second key pair against the first public key 183. Modifying the second key pair after digital signature would destroy the digital signature in that the second key pair could no longer be authenticated against the first public key 183, and thus securely node-locks the second key pair.

Execution of the operating system 184 causes the computing device to then delete the first private key 182 from the license device 180 (110), resulting in the license device 180 storing the first public key 183 and the operating system 184 (and no longer the first private key 182). The first private key 182 is securely deleted, so that it cannot be later recovered from the license device 180. Execution of the operating system 184 causes the computing device to then store the node-locked second key pair on the license device 180 (112), resulting in the license device 180 now storing the first public key 183, the second public key 187 and the second private key 186 (i.e., the second key pair), and the operating system 184.

The second public and private keys 187 and 186 as stored on the license device 180 are digitally signed with the now-deleted first private key 182, but are authenticable against the first public key 183 stored on the device 180. The process at the factory is thus finished. Therefore, execution of the operating system 184 causes the computing device to then shut down (114), permitting removal of the license device 180 from the computing device (116). That is, once the operating system 184 has generated, digitally signed, and copied the second public and private keys 187 and 186 to the license device 180, the operating system 184 shuts down.

At the conclusion of the method 100, the license device 180 can be sent to an end user, or to a reseller that will provide it to an end user upon sale. Upon leaving the factory, the license device 180 does not yet store the node-locked and time-restricted license that governs usage of the operating system 184. The operating system 184 has the capability to generate the node-locked and time-restricted license at first use by the end user, to permit subsequent license-governed usage of the operating system 184 to run other computer programs, and so on. Rather, upon leaving the factory, the license device 180 stores the first public key 183, the node-locked second public and private keys 187 and 186, and the operating system 184.

Referring to FIG. 1B, the method 120 is performed at first use of the live distribution of the operating system 184 stored on the license device 180 by the end user. The first use by the end user is the second boot of the operating system 184, since the operating system 184 was previously booted at the factory in FIG. 1A. The method 120 includes inserting the license device 180 into a computing device by the end user (122). The end user here can mean the user who wants to use the operating system 184 to run computer programs on the operating system 184 regardless of the computing device in which the license device 180 is inserted, and who may copy such programs to the device 180. The end user may be an organization, such as a company, family, or other entity, where one person initiates performance of the method 120 for subsequent usage of the license device 180 by another person or persons.

At time of insertion of the license device 180 into a computing device in part 122, the first public key 183, the second public and private keys 187 and 186, and the operating system 184 already reside on the device 180. The first private key 182 of FIG. 1A does not reside on the license device 180 (i.e., is not stored on) at time of insertion of the license device 180 into the computing device, and thus is unavailable to the processor of the computing device performing the method 120. Because the distribution of the operating system 184 is a live distribution, the computing device boots the operating system 184 directly from the license device 180 (124), without having to copy the operating system 184 to or install the operating system 184 on the computing device. This is the second boot of the operating system 184 overall, and the first boot of the operating system 184 outside the factory.

Execution of the operating system 184 causes the computing device to generate a license and digitally sign the license with the second private key 186 (126). The license may be a data file that encodes the licensing terms of the operating system 124, such as how long the operating system 124 can be used upon first use by the end user. For example, the licensing terms may specify that the operating system 124 can be used for a period of days, months, or years from first use by the end user. As another example, the licensing terms may specify that the operating system 124 is to contact a server to determine if the operating system 124 is currently licensed.

Digitally signing the license with the second private key 186 node-locks the license to the license device 180. This is because the second private key 186 is itself node-locked to the license device 180. Digitally signing the license with the second private key 186 also time-restricts the license to the current time, which is the current system time of the computing device in which the license device 180 has been inserted. This is because the digital signature process timestamps the digitally signed license with the current time. Modifying the license after digital signature would destroy the digital signature in that the license could no longer be authenticated against the second public key 187, and thus securely node-locks and time-restricts the license.

The user may be given the opportunity to verify the current system time of the computing device before the operating system 184 generates and digitally signs the license with the second private key 186. If the current system time is incorrectly in the past, the end user will be unable to avail him or herself of the entire license period, because a portion of the license period will have already passed. If the current system time is in the future, the end user will not be able to begin using the operating system 184 to run computer programs, and so on, until the future time has arrived. In some situations, however, the end user may wish to postdate the time at which the operating system 184 can be used in this manner.

Prior to digitally signing the license with the second private key 186, the operating system 184 may authenticate the second private key 186 against the first public key 183. If authentication fails, this means that that the second private key 186 or the first public key 183 may have been compromised on the license device 180, and therefore the license is not signed. Similarly, the operating system 184 may authenticate the first public key 183 if it is not self-signed, such as against the certificate authority that digitally signed the first public key 183, which means that the computing device will have to have network connectivity to communicate with the certificate authority. If authentication fails, this means that the first public key 183 may have been comprised, and therefore the license device is similarly not signed.

Execution of the operating system 184 causes the computing device to then delete the second private key 186 from the license device 180 once the license has been generated and digitally signed with the second private key 186 (128). The second private key 186 is securely deleted, so that it cannot be later recovered from the license device 180. The result of part 128 is that the license device 180 now stores the first public key 183, the second public key 187, and the operating system 184 (and no longer the second private key 186). Execution of the operating system 184 then causes the computing device to copy the digitally signed (and thus node-locked and time-restricted) license to the license device 180 (130), resulting in the license device 180 now storing the first public key 183, the second public key 187, the license 188, and the operating system 184.

At this time, the user may wish to use the operating system 184 (132) to run computer programs, and otherwise control the computing device for the reasons that the user acquired the license device 180 on which the operating system 184 is stored. The user may copy or install computer programs on the license device 180, for instance, and may then use these programs. Other computer programs may have been preinstalled at the factory. The user may further perform other setup and configuration of the operating system 184 if desired.

If the user uses the operating system 184 in part 132, the user at some point can cause the operating system 184 to shut down (134), permitting removal of the license device 180 from the computing device (136). The license device 180 can then be reinserted into the same computing device or inserted into another computing device to use the live distribution of the operating system 184 to again run computer programs in conjunction with the operating system 184. The user may instead not be permitted to or may not wish to immediately use the operating system 184 in part 132, in which case execution of the operating system 184 may cause the computing device to shut down, as in part 114 of FIG. 1A.

Referring to FIG. 1C, the method 140 is performed at each subsequent use of the live distribution of the operating system 184 stored on the license device 180, by the same or different end user that cause FIG. 1B to be performed. The first end user subsequent use is the second end user use of the operating system 184, and is the third overall use of the operating system 184, since the first use of the operating system 184 occurred at the factory in FIG. 1A. The method 140 includes inserting the license device 180 into a computing device by the end user (142). At time of insertion, the license device 180 stores the first public key 183, the node-locked second public key 187, the node-locked and time-restricted license 188, and the operating system 184.

Because the distribution of the operating system 184 is a live distribution, the computing device boots the operating system 184 directly from the license device 180 (144), without having to copy the operating system 184 to or install the operating system 184 on the computing device. Execution of the operating system 184 causes the computing device to authenticate the license 188 against the second public key 187 (146). If authentication fails, this means that the license 188 or the second public key 187 may have been compromised on the license device 180, and the method 140 prematurely terminates. That is, the operating system 184 may immediately shut down, and not permit execution of other computer programs on the operating system 184 and thus on the computing device in which the license device 180 is inserted.

Execution of the operating system 184 also causes the computing device to authenticate the second public key 187 against the first public key 183 (148). If authentication fails, this means that the second public key 187 or the first public key 183 may have been compromised on the license device 180, and the method 140 prematurely terminates. Execution of the operating system 184 may similarly cause the computing device to authenticate the first public key 183 if it is not self-signed (149), such as against the certificate authority that digitally signed the first public key 183. If authentication fails, this means that the first public key 183 may have been compromised on the license device 180, and the method 140 prematurely terminates.

Execution of the operating system 184 further causes the computing device to validate the license 188 against the license device 180 (150). That is, the operating system 184 verifies that the license device to which the license 188 is node-locked is the license device 180 inserted into the computing device. For example, the operating system 184 can verify that the unique identifier encoded in the second public key 187 is the unique identifier of the license device 180. If verification fails, this means that the license 188 may have been compromised, or may have been copied to a different license device than the license device 180, and the method 140 prematurely terminates.

Execution of the operating system 184 similarly causes the computing device to validate the license 188 against the current time (152). That is, the operating system 184 verifies that the current system time of the computing device in which the license device 180 has been inserted falls within the license period of the license 188 that began with the time at which the license 188 was digitally signed in FIG. 1B. If verification fails, this means that the license 188 may have been compromised, or that the license period for usage of the operating system 184 has elapsed or expired, and the method 140 prematurely terminates.

To prevent a user from backdating the current system time to in effect improperly extend the license period, the operating system 184 may securely record the current time every time the operating system 184 is booted in part 144. If the current system time predates the most recently secured recorded time (such as by more than a threshold), then the method 140 prematurely terminates. If the authentication of parts 146 and 148 (and part 149) is successful, and if the validation of parts 150 and 152 is successful, then the operating system 184 does not prematurely terminate, and the user can use the operating system 184 (154) to run computer programs and otherwise control the computing device for the reasons that the license device 180 storing the operating system 184 was acquired, as in part 132 of FIG. 1B.

At some point the user can cause the operating system 184 to shut down (156), permitting removal of the license device 180 from the computing device (158). The license device 180 can then be reinserted into the same computing device or inserted into another computing device to again use the live distribution of the operating system 184. Each time the operating system 184 is booted, the method 140 is repeated to authenticate the license 188 and the second public key 187 (and the first public key 183) and to validate the license 188 against the license device 180 and against the current time, before the operating system 184 can be effectively used.

The techniques described in relation to FIGS. 1A, 1B, and 1C pertain to an implementation in which an operating system 184 stored on the license device 180 is subject to the node-locked and time-restricted license 188. However, in another implementation, software that is stored on the license device 180 and that is not an operating system can be subject to the license 188. In still another implementation, the license 188 stored on the license device 180 may govern usage of software at the computing device in which the device 180 has been inserted and that is not stored on the license device 180, or may be used for another purpose. For example, the software in either case can be a computer program, like an application computer program.

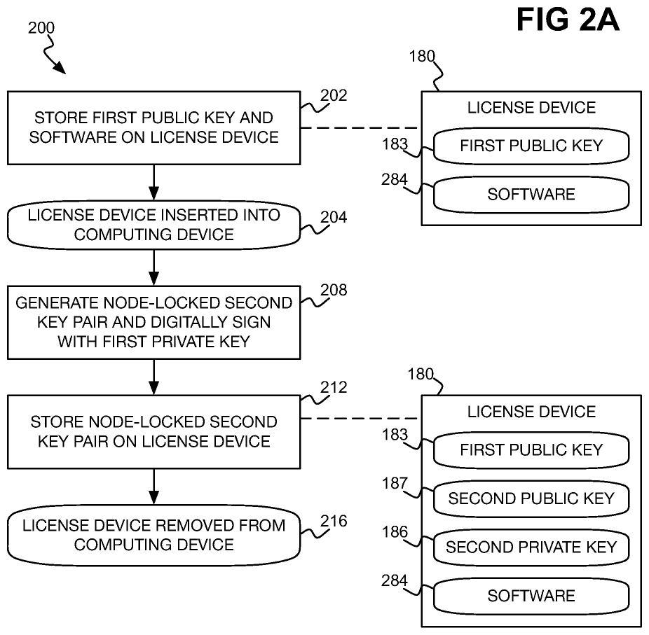

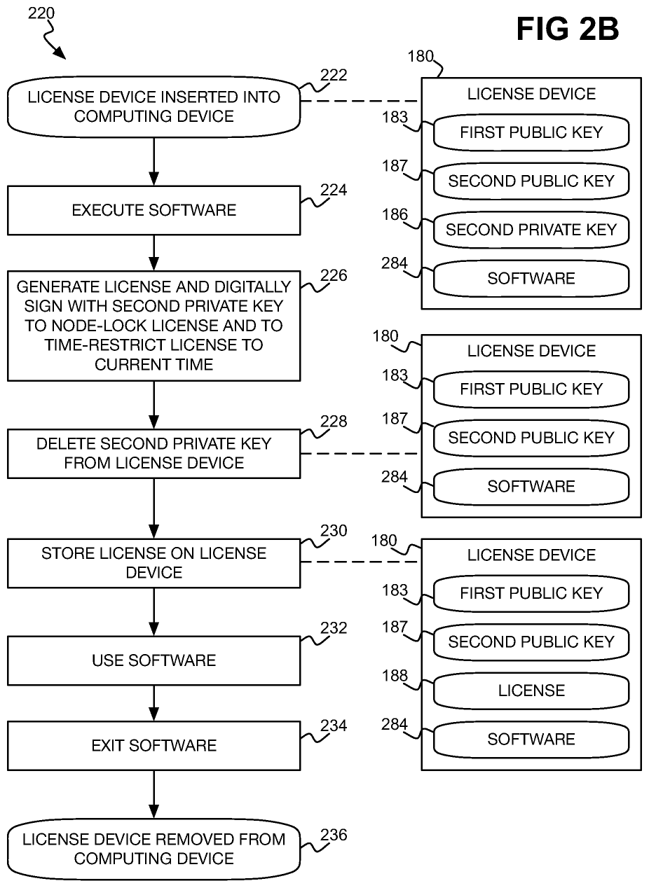

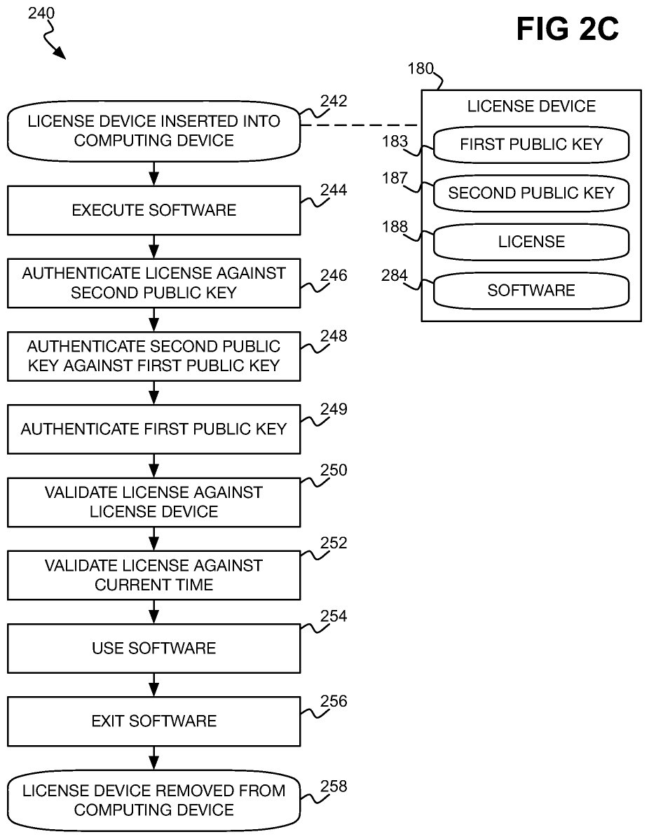

FIGS. 2A, 2B, and 2C show respective example methods 200, 220, and 240 for a node-locked and time-restricted license for standalone software that is not an operating system and that is stored on and executable from a license device. That is, the software is standalone in that it can be executed directly from the license device without first having to be copied to or installed on a computing device to which the license device is connected. At least some parts of the methods 200, 220, and 240 may be implemented as program code stored on a non-transitory computer-readable data storage medium and executable by a processor. The program code may be the software stored on the license device, the data storage medium may be or be part of the license device, and the processor may be part of the computing device to which the license device has been communicatively connected.

Referring to FIG. 2A, the method 200 is performed at time of manufacture, such as at the factory, to manufacture a license device storing standalone software. The method 200 includes storing a first public key of a first cryptographic key pair and the software on the license device (202), similar to part 102 of FIG. 1A but to copy software other than an operating system and without having to copy a first private key of the first key pair. The result of part 202 is the license device 180 storing the first public key 183 and the software 284. In another implementation, however, the first private key may also be copied to and thus stored on the license device 180. The method 100 includes inserting the license device 180 into a computing device at the factory and which is itself already running an operating system (204).

The method 200 includes generating a node-locked second cryptographic key pair and digitally signing the second key pair with the first private key of the first key pair (208). Part 208 is performed similar to part 108 of the method 100, but is performed by the computing device executing software other than the software 284 stored on the license device 180 (e.g., by the operating system and/or other software stored on the computing device itself). However, in another implementation part 208 is performed by executing the software 284 stored on the license device 180.

The method 200 includes storing the node-locked second key pair on the license device 180 (212). Part 212 is performed similar to part 112 of the method 100, but as with part 206 may (or may not) be performed by software other than the software 284 stored on the license device 180. In the implementation in which the first private key is copied to the license device 180, the first private key is securely deleted from the license device 180 before the second key pair is stored on the device 180. The result of part 212 is that the license device 180 now stores the first public key 183, the second public key 187 and the second private key 186 (i.e., the second key pair), and the software 284. The license device 180 can now be removed from the computing device (216), for providing to an end user or to a reseller that will provide the device 180 to an end user.

Referring to FIG. 2B, the method 220 is performed at first use of the software 284 stored on the license device 180 by the end user. The method 220 includes inserting the license device 180 into a computing device by the end user (222). The computing device executes its own operating system—i.e., an operating system not stored on the license device 180. At time of insertion, the license device 180 stores the first public key 183, the second public and private keys 187 and 186, and the software 284. The first private key corresponding to the first public key 183 is not stored on the license device 180, and thus is unavailable to the processor of the computing device performing the method 220.

Because the software 284 is standalone, the computing device can execute the software 284 directly from the license device 180 (224), without having to copy the software 284 to or install the software 284 on the computing device. Execution of the software 284 causes the computing device to generate a license and digitally sign the license with the second private key 186 (226). Part 226 can be performed similar to part 126 of FIG. 1B, but by the software 284. As a result of digital signature with the second private key 186, the license is time-restricted to the current system time and node-locked to the license device 180. The software 284 may authenticate the second private key 186 against the first public key 183 and may authenticate the first public key 183 (if not self-signed) prior to digitally signing the license.

Execution of the software 284 causes the computing device to then securely delete the second private key 186 from the license device 180 once the license has been generated and digitally signed with the second private key 186 (228). Part 228 can be performed similar to part 128 of FIG. 1B, but by the software 284. The result of part 228 is that the license device 180 now stores the first public key 183, the second public key 187, and the software 284 (and no longer the second private key 186). Execution of the software 284 then causes the computing device to copy the digitally signed (and thus node-locked and time-restricted) license to the license device 180 (230), resulting in the license device 180 now storing the first public key 183, the second public key 187, the license 188, and the software 284. Part 230 can be performed similar to part 130 of FIG. 1B, but by the software 284.

At this time, the user may wish to use the software 284 (232) on the computing device in which the license device 180 is inserted. If the user uses the software 284, at some point he or she can exit the software 284 (234) (i.e., terminate execution of the software 284), permitting removal of the license device 180 from the computing device (236). The license device 180 can then be inserted into the same or different computing device to use the standalone software 284 to again run the software 284. The user may instead not be permitted to or may not wish to immediately use the software 284 in part 232, in which case the software 284 may automatically exit.

Referring to FIG. 2C, the method 240 is performed at each subsequent use of the standalone software 284 stored on the license device 180, by the same or different end user that caused FIG. 2B to be performed. The method 240 includes inserting the license device 180 into a computing device by the end user (242). At time of insertion, the license device 180 stores the first public key 183, the node-locked second public key 187, the node-locked and time-restricted license 188, and the software 284. The computing device executes its own operating system—i.e., an operating system not stored on the license device 180.

Because the software 284 is standalone, the computing device can execute the software 284 directly from the license device 180 (244) without having to copy the software 284 to or install the software 284 on the computing device. Execution of the software 284 causes the computing device to authenticate the license 188 against the second public key 187 (246), and authenticate the second public key 187 against the first public key 183 (248). Parts 246 and 248 are performed similar to parts 146 and 148 of FIG. 1C, but by the software 284. Execution of the software 284 may also cause the computing device to authenticate the first public key 183 if not self-signed (249), similar to part 149 of FIG. 1C but again by the software 284.

Execution of the software 284 further causes the computing device to validate the license 188 against the license device 180 (250) and against the current time (252), similar to parts 150 and 152 of FIG. 1C, but by the software 284. If the authentication of part 246 and 248 (and part 249) is successful, and if the validation of parts 250 and 252 is successful, then the software 284 does not prematurely terminate, and the user can use the software 284 (254) for the reasons that the license device 180 storing the software 284 was acquired.

At some point the user can exit the software (256), permitting removal of the license device 180 from the computing device (258). The license device 180 can then be reinserted into the same or different computing device to again use the standalone software 284. Each time the software 284 is executed, the method 240 is repeated to authenticate the license 188 and the second public key 187 (and the first public key 183) and to validate the license 188 against the license device 180 and against the current time, before the software 284 can be effectively used.

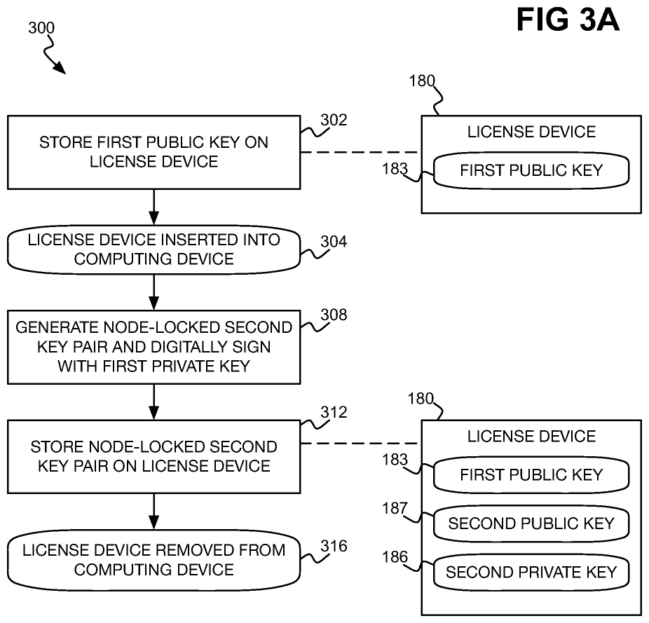

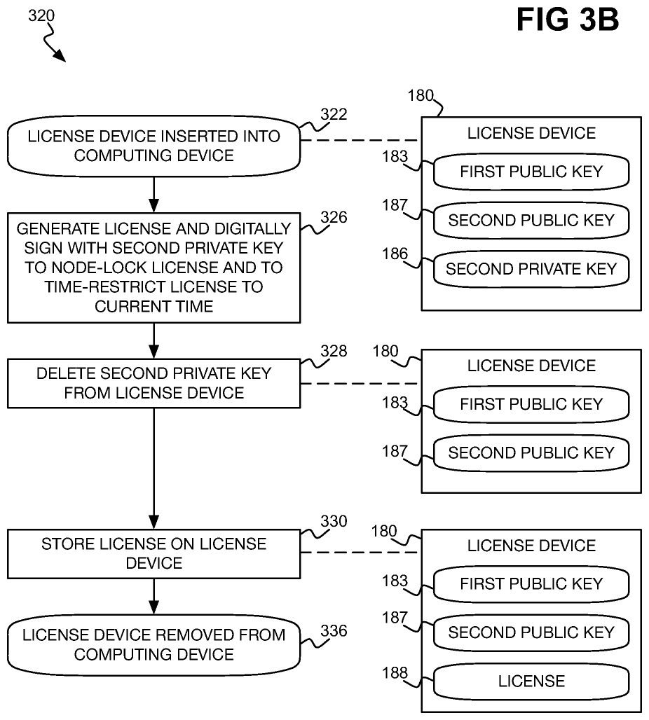

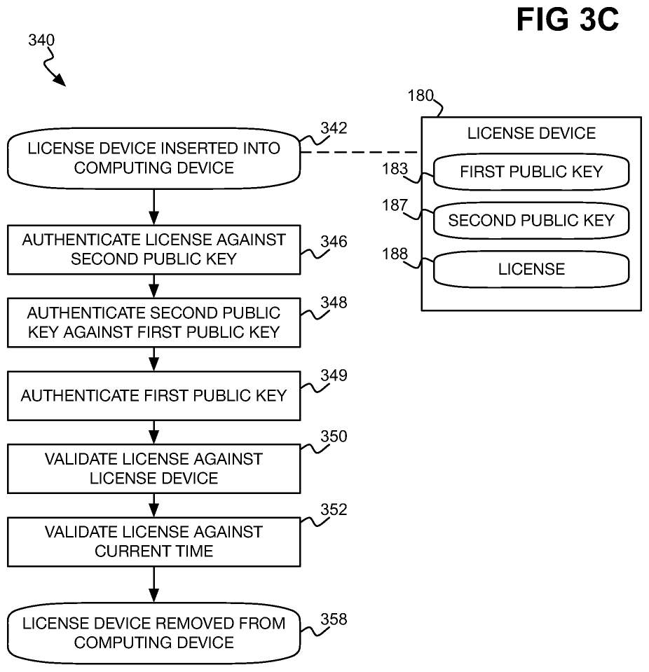

FIGS. 3A, 3B, and 3C show respective example methods 300, 320, and 340 for a node-locked and time-restricted license that is stored on a license device. The license can be for software, including an operating system, that is not stored on the license device. The license can be used for a different reason as well. At least some parts of the methods 300, 320, and 340 may be implemented as program code stored on a non-transitory computer-readable data storage medium and executable by a processor, such as a processor that is part of the computing device to which the license device has been communicatively connected.

Referring to FIG. 3A, the method 300 is performed at time of manufacture, such as at the factory, to manufacture a license device. The method 300 includes storing a first public key of a first cryptographic key pair on the license device (302), similar to part 202 of FIG. 2B but without having to copy a first private key of the firs key pair or any software to the license device. The result of part 302 is the licensing device 180 storing the first public key 183. However, in another implementation the first private key may also be stored on the licensing device 180. The method 300 includes inserting the license device 180 into a computing device at the factory (304), which generates a node-locked second cryptographic key pair and digitally signs the second key pair with the first private key of the first key pair (308), as in part 208 of FIG. 2A.

The method 300 includes storing the node-locked second key pair on the license device 180 (312), as in part 212 of FIG. 2A. In the implementation in which the first private key is copied to the license device 180, the first private key is securely deleted from the license device 180 before the second key pair is stored on the device 180. The result of part 312 is that the license device 180 now stores the first public key 183, and the second public key 187 and the second private key 186 (i.e., the second key pair). The license device 180 can now be removed from the computing device (316), for providing to an end user or to a reseller that will provide the device 180 to an end user.

Referring to FIG. 3B, the method 320 is performed to activate the license stored on the license device 180 by the end user. That is, the method 320 is performed to start tolling of the license period of the license. The method 320 includes inserting the license device 180 into a computing device by the end user (322). At time of insertion, the license device 180 stores the first public key 183, and the second public and private keys 187 and 186. The first private key corresponding to the first public key 183 is not stored on the license device 180, and thus is unavailable to the processor of the computing device performing the method 320.

A license is generated and digitally signed with the second private key 186 (326), as in part 226 of FIG. 2A but by software not stored on the license device 180. As a result of digital signature with the second private key 186, the license is time-restricted to the current system time and node-locked to the license device 180. The second private key 186 may be authenticated against the first public key 183, and the first public key 183 may also be authenticated if not self-signed, prior to the license being digitally signed.

The second private key 186 is then securely deleted from the license device 180 (328), as in part 228 of FIG. 2A but by software not stored on the license device 180. The result of part 328 is that the license device 180 now stores the first public key 183 and the second public key 187. The digitally signed (and thus node-locked and time-restricted) license is copied to the license device 180 (330), as in part 230 of FIG. 2A but by software not stored on the license device 180. The result of part 330 is that the license device 180 now stores the first public key 183, the second public key 187, and the license 188.

As noted, the license 188 may govern usage of software that is not stored on the license device 180. When the software is started on the computing device, it may perform the method 320 to generate the license 188. Once the license 188 has been generated and the license has been stored on the license device 180, the user may then use the software as intended. At some point the license device 180 can be removed from the computing device (336).

In one implementation, the license device 180 may be removed after the license 188 has been generated and stored on the device 180, even if the user is still using the software governed by the license 188. In another implementation, the software may periodically check for the license 188 during execution, in which case the license device 180 cannot be removed until after the software has been exited. The license device 180 may later be inserted into the same or different computing device to again use the license 188, such as to again run the software governed by the license 188.

Referring to FIG. 3C, the method 340 is performed each time the license 188 stored on the license device 180 is to be used. The method 340 may be performed, for example, each time software that is governed by the license 188 is to be used, by the same or different end user that caused FIG. 3B to be performed. The method 340 includes inserting the license device 180 into a computing device by the end user (342). At time of insertion, the license device 180 stores the public key 183, the node-locked second public key 187, and the node-locked and time-restricted license 188.

The license 188 is authenticated against the second public key 187 (346), and the second public key 187 is authenticated against the first public key 183 (348), as in parts 246 and 248 but by software not stored on the license device 180. The first public key 183 may also be authenticated (349) if not self-signed, as in part 249 but by software not stored on the license device 180. The license 188 is validated against the license device 180 (350) and against the current time (352), as in parts 250 and 252 but again by software not stored on the license device 180.

The software not stored on the license device 180 may have its usage governed by the license 188. If the authentication of parts 346 and 348 (and part 349) is successful, and if the validation of parts 350 and 352 is successful, then the user may use the software as intended. If the authentication in part 346 or 348 (or part 349) is unsuccessful, or if the validation of part 350 or part 352 is unsuccessful, then the software may terminate, preventing the user from using the software as intended.

At some point the license device 180 can be removed from the computing device (358). In one implementation, the license device 180 may be removed after successful authentication in parts 346 and 348 (and part 349) and after successful validation in parts 350 and 352, even if the user is still using the software governed by the license 188. In another implementation, the software may periodically check for the license 188 during execution, in which case the license device 180 cannot be removed until after the software has been exited.

Upon removal, the license device 180 can be reinserted into the same or different computing device to again use the software governed by the license 188. Each time the software is started, the method 340 is repeated to authenticate the license 188 and the second public key 187 (and the first public key 183) and to validate the license 188 against the license device 180 and against the current time, before the software can be effectively used.

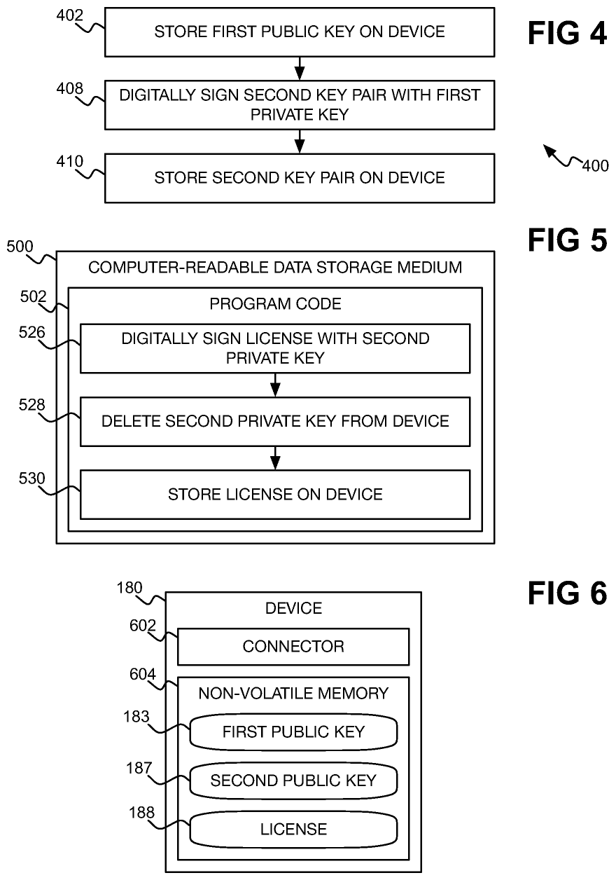

FIG. 4 shows an example method 400. The method 400 includes storing a first public key of a first cryptographic key pair on a device (402). The method 400 include digitally signing, with a first private key of the first cryptographic key pair, a second cryptographic key pair of second public and private keys node-locked to the device (404). The method 400 includes storing the second public and private keys on the device (406). The second private key is adapted to later time-restrict a license and node-lock the license to the device; that is, the second private key is such that it provides for provides for subsequent time-restricting and node-locking of the license.

FIG. 5 shows an example non-transitory computer-readable data storage medium 500 storing program code 502 executable by a processor to perform processing. The processing includes digitally signing a license with a second private key of a second cryptographic key pair stored on a device and node-locked to the device, to time-restrict the license to a current time and to node-lock the license to the device (526). The second cryptographic key pair is digitally signed with a first private key of a first cryptographic key pair including a first public key stored on the device. The processing includes deleting the second private key from the device (528), and storing the license on the device (530).

FIG. 6 shows an example device 180. The device 180 includes a connector 602, such as a USB connector, to connect the device to a computing device having a processor. The device 180 includes a non-volatile memory 604. The non-volatile memory 604 stores a first public key 183 of a first cryptographic key pair. The non-volatile memory 604 stores a second public key 187 of a second cryptographic key pair digitally signed with a first private key of the first cryptographic key pair and node-locked to the device 180. The non-volatile memory 604 stores a license 188 digitally signed with a second private key of the second cryptographic key pair to node-lock the license 188 to the device 180. The license 188 is time-restricted to a time at which the license 188 was digitally signed with the second private key. The processor is to authenticate the license 188 against the second public key 187, authenticate the second public key 187 against the first public key 183, and validate the license 188 against the device 180 and against a current time.

Techniques have been described for providing a license device that stores a time-restricted license that is node-locked to the license device. The license is time-restricted to the time of first use of the license device by an end user (i.e., not at the factory). The license device can store standalone software, such as a live distribution of an operating system, that is executable directly from the license device upon insertion of the license device into a computing device. The license device stores the node-locked second public key that is generated at first use of the license device by the end user and against which the license is authenticated, and the first public key against which the second public key is authenticated.

We claim:

1. A method comprising:
storing a first public key of a first cryptographic key pair on a device;
digitally signing, with a first private key of the first cryptographic key pair, a second cryptographic key pair of second public and private keys node-locked to the device; and
storing the second public and private keys on the device,
wherein the second private key is to later time-restrict a license and node-lock the license to the device.

2. The method of claim 1, wherein the license is node-locked to the device at and time-restricted to a time at which the license is digitally signed by the second private key, the second private key deleted upon digital signature of the license,
and wherein the license is:
node-locked to the device due to the second private key being node-locked to the device, and
authenticable against the second public key stored on the device and the second public key is authenticable against the first public key stored on the device.

3. The method of claim 1, further comprising:
storing software governed by the license stored on the device.

4. The method of claim 3, wherein the software comprises a standalone operating system executable from the device,
and wherein digitally signing the second cryptographic key pair occurs at first boot of and during execution of the operating system from the device.

5. The method of claim 1, further comprising:
storing the first private key on the device; and
after digitally signing the second cryptographic key pair with the first private key, deleting the first private key from the device prior to storing the second key pair on the device.

6. A non-transitory computer-readable data storage medium storing program code executable by a processor to:
digitally sign a license with a second private key of a second cryptographic key pair stored on a device and node-locked to the device, to time-restrict the license to a current time and to node-lock the license to the device, the second cryptographic key pair digitally signed with a first private key of a first cryptographic key pair including a first public key stored on the device;
delete the second private key from the device; and
store the license on the device.

7. The non-transitory computer-readable data storage medium of claim 6, wherein the first private key is not stored on the device and the first private key is unavailable to the processor.

8. The non-transitory computer-readable data storage medium of claim 6, wherein the processor is further to:
authenticate the license stored on the device against the second public key stored on the device;
authenticate the second public key stored on the device against the first public key stored on the device;
validate the license against the device; and
validate the license against a current time.

9. The non-transitory computer-readable data storage medium of claim 8, wherein the program code comprises software governed by the license,
and wherein the processor digitally signs the license with the second private key, deletes the second private key from the device, and stores the license on the device during execution of the software.

10. The non-transitory computer-readable data storage medium of claim 6, wherein the program code comprises a standalone operating system governed by the license, and the processor is further to:
boot the operating system stored on the device,
wherein the processor digitally signs the license with the second private key, deletes the second private key from the device, and stores the license on the device during execution of the booted operating system.

11. A device comprising:
a connector to connect the device to a computing device having a processor; and
a non-volatile memory storing:
a first public key of a first cryptographic key pair;
a second public key of a second cryptographic key pair digitally signed with a first private key of the first cryptographic key pair and node-locked to the device; and
a license digitally signed with a second private key of the second cryptographic key pair to node-lock the license to the device, the license time-restricted to a time at which the license was digitally signed with the second private key,
wherein the processor is to authenticate the license against the second public key, authenticate the second public key against the first public key, and validate the license against the device and against a current time.

12. The device of claim 11, wherein the license is node-locked to the device due to the second private key being node-locked to the device.

13. The device of claim 11, wherein the first private key is not stored on the device and is unavailable to the processor, and the device further stores the second private key,
wherein the processor is to digitally sign the license with the second private key to time-restrict the license to a time of digital signature and to node-lock the license to the device, and is to delete the second private key from the device upon digital signature of the license.

14. The device of claim 11, wherein the non-volatile memory further stores software governed by the license,
and wherein the processor is to execute the software, the processor authenticating the license and the second public key, and validating the license against the device and against the current time during execution of the software.

15. The device of claim 11, wherein the non-volatile memory further stores a standalone operating system,
wherein the processor is to boot the operating system, the processor authenticating the license and the second public key, and validating the license against the device and against the current time during execution of the booted operating system.
